(19) United States
(12) Patent Application Publication
(10) Pub. No.: US 2013/0321276 A1
(43) Pub. Date: Dec. 5, 2013

(54) ELECTRONIC APPARATUS, IMAGE DATA DISPLAY CONTROL METHOD AND COMPUTER-READABLE MEDIUM

(71) Applicant: KABUSHIKI KAISHA TOSHIBA, Tokyo (JP)

(72) Inventor: Qi ZHANG, Tokyo (JP)

(73) Assignee: KABUSHIKI KAISHA TOSHIBA, Tokyo (JP)

(21) Appl. No.: 13/719,844

(22) Filed: Dec. 19, 2012

(30) Foreign Application Priority Data
May 31, 2012 (JP) 2012-125469

(51) Int. Cl. G06F 3/02

(52) U.S. Cl. CPC G06F 3/02
USPC 345/168

(57) ABSTRACT

According to one embodiment, an electronic apparatus includes an input module, a controller and a determination module. The input module includes a plurality of keys. The controller displays a primary image and a secondary image which indicates an input position on the primary image. The determination module determines a position of the secondary image in an area of the primary image based on a position of the key inputted in an area of the input module.

### CROSS-REFERENCE TO RELATED APPLICATION(S)

This application is based upon and claims the benefit of priority from Japanese Patent Application No. 2012-125469, filed May 31, 2012; the entire contents of (all of) which are incorporated herein by reference.

### FIELD

Embodiments described herein relate generally to an electronic apparatus, an image data display control method and a computer-readable medium for displaying a cursor on a display.

### BACKGROUND

Various electronic apparatuses for displaying a cursor together with an image on a display device have been heretofore provided. In such an electronic apparatus, for example, there is a technique for moving a cursor to a predetermined position on a screen of the display device by pushing down a plurality of keys in a remote controller.

### BRIEF DESCRIPTION OF THE DRAWINGS

FIG. 1 is a perspective view showing external appearance in common to electronic apparatuses according to an embodiment.

FIG. 2 is a block diagram showing system configuration in common to electronic apparatuses according to an embodiment.

FIG. 3 is a conceptual view showing a process for generating image data in common to electronic apparatuses according to an embodiment.

FIG. 4 is a flow chart showing a procedure of an image data generating process performed by an electronic apparatus according to Example 1.

FIG. 5 is a view showing correspondence between a keyboard and a display screen in common to electronic apparatuses according to an embodiment.

FIG. 6 is a view showing a cursor display position in common to electronic apparatuses according to an embodiment.

FIG. 7 is a view showing correspondence between a keyboard and a display screen in the electronic apparatus according to Example 1.

FIGS. 8A and 8B are views showing correspondence between a keyboard and a display screen in common to electronic apparatuses according to an embodiment.

FIG. 9 is a flow chart showing a procedure of an image data generating process performed by an electronic apparatus according to Example 2.

FIGS. 10A and 10B are views showing a cursor display position in the electronic apparatus according to Example 2.

FIGS. 11A and 11B are views showing a cursor display position in the electronic apparatus according to Example 2.

### DETAILED DESCRIPTION

According to one embodiment, an electronic apparatus includes an input module, a controller and a determination module. The input module includes a plurality of keys. The controller displays a primary image and a secondary image which indicates an input position on the primary image. The determination module determines a position of the secondary image in an area of the primary image based on a position of the key inputted in an area of the input module.

Various embodiments will be described hereinafter with reference to the accompanying drawings.

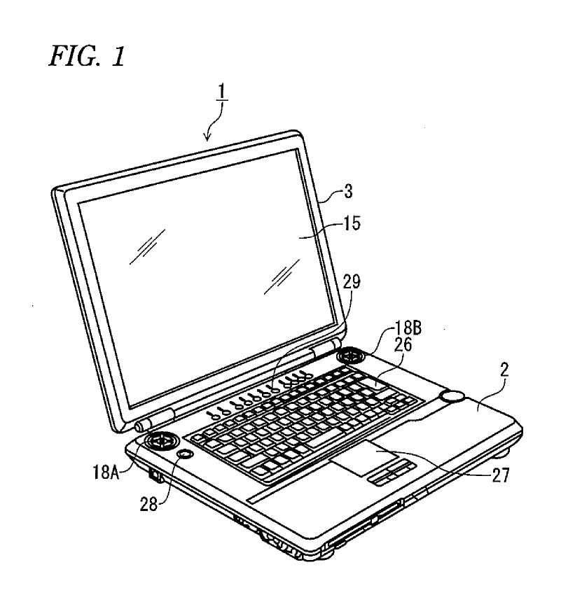

FIG. 1 is a perspective view showing the external appearance of an electronic apparatus according to an embodiment. For example, the electronic apparatus is implemented as a notebook type personal computer 1. As shown in FIG. 1, the computer I includes a computer body 2, and a display module 3.

An LCD (liquid crystal display) 15 is put in the display module 3. The display module 3 is attached to the computer body 2 so that the display module 3 can rotate desirably between an open position where an upper surface of the computer body 2 is exposed and a close position where the upper surface of the computer body 2 is covered.

The computer body 2 has a housing shaped like a thin box. A keyboard 26, a power button 28 for powering on/off the computer 1, an input operation panel 29, a touch pad 27, speakers 18A and 18B, etc. are disposed in the upper surface of the computer body 2. Various kinds of operation buttons are provided on the input operation panel 29. The button group includes an operation button group for controlling television (hereinafter referred to as TV) functions (viewing, recording and displaying recorded TV broadcast data/video data). A remote control interface 30 for executing communication with a remote controller which remotely controls the TV functions of the computer 1 is provided in a front surface of the computer body 2. For example, the remote control interface 30 includes an infrared signal reception portion etc. so that the TV functions can be controlled based on remote control performed by the remote controller.

An external display connection terminal (not shown), for example, based on the HDMI (high-definition multimedia interface) Standard is provided, for example, in a rear surface of the computer body 2. The external display connection terminal is used for outputting video data (motion image data) contained in video content data such as TV broadcast data to an external display.

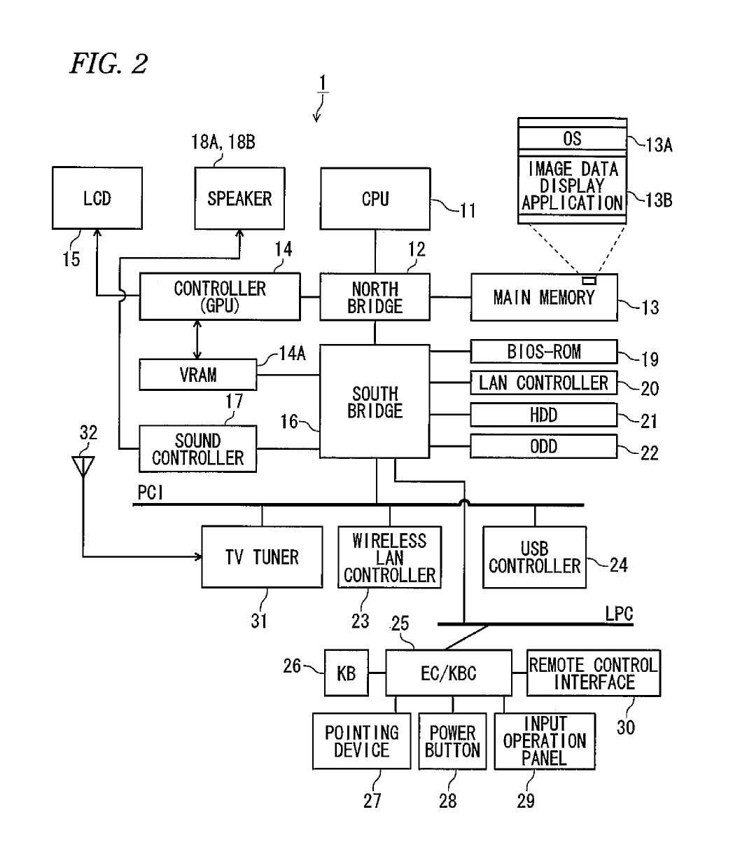

FIG. 2 is a diagram showing the system configuration of the computer 1. As shown in FIG. 2, the computer 1 has a CPU 11, a north bridge 12, a main memory 13, a controller 14, a video memory (VRAM) 14A, an LCD (Liquid Crystal Display) 15, a south bridge 16, a sound controller 17, speakers 18A and 18B, a BIOS-ROM 19, an LAN controller 20, a hard disk drive (HDD) 21, an optical disk drive (ODD) 22, a wireless LAN controller 23, a USB controller 24, an embedded controller/keyboard controller (EC/KBC) 25, a keyboard (KB) 26, a pointing device 27, a power button 28, an input operation panel 29, a remote control interface 30, a TV tuner 31, a TV broadcast reception antenna 32, etc.

The CPU 11 is a processor which controls operation of the computer 1. The CPU 11 executes an operating system (OS) 13A and application programs such as an image data display application program 13B, loaded from the HDD 21 to the main memory 13. The display image data display application program 13B is software having a function for viewing video content data. The display image data display application program 13B executes a display process etc. for displaying primary image data such as image data acquired through the Internet and image data stored in the HDD 21. The display image data display application program 13B further has a function of performing a display process etc. for displaying secondary image data such as a cursor used for operation by a user. The display image data display application program 13B displays the secondary image data such as image data or a cursor superposed on the primary image data on a screen of the LCD 15. The term “cursor” used herein means a mark indicating a position where inputting is performed on a display screen. Configuration may be made so that a target of selection can be selected by operation such as clicking when the target of selection is displayed in the position where the cursor is displayed.

The CPU 11 further executes a BIOS (Basic Input/Output System) stored in the BIOS-ROM 19. The BIOS is a program for hardware control.

The north bridge 12 is a bridge device which connects a local bus of the CPU 11 and the south bridge 16 to each other. The north bridge 12 has a built-in memory controller for access control of the main memory 13. The north bridge 12 further has a function of executing communication with the controller 14.

The controller 14 is a device which controls the LCD 15 used as a display of the computer 1. A display signal generated by the controller 14 is sent to the LCD 15. The LCD 15 displays video based on the display signal.

The south bridge 16 controls respective devices on a PCI (Peripheral Component Interconnect) bus and an LPC (Low Pin Count) bus. The south bridge 16 has a built-in IDE (Integrated Drive Electronics) controller for controlling the HDD 21 and the ODD 22, and a built-in memory controller for access control of the BIOS-ROM 19. The south bridge 16 further has a function of executing communication with the sound controller 17 and the LAN controller 20.

The sound controller 17 is a sound source device which outputs audio data as a subject of display to the speakers 18A and 18B. The LAN controller 20 is a wire communication device which executes wire communication, for example, based on the Ethernet (registered trademark) Standard. The wireless LAN controller 23 is a wireless communication device which executes wireless communication, for example, based on the IEEE 802.11 Standard. The USB controller 24 executes communication with an external device through a cable, for example, based on the USB2.0 Standard.

The EC/KBC 25 is a one-chip microcomputer into which an embedded controller for performing power management and a keyboard controller for controlling the keyboard (KB) 26 and the pointing device 27 are integrated. The EC/KBC 25 has a function of powering on/off the computer 1 in accordance with user's operation on the power button 28. The EC/KBC 25 further has a function of executing communication with the remote control interface 30.

The TV tuner 31 is a reception device which receives TV broadcast data broadcasted as a TV broadcast signal through the TV broadcast reception antenna 32. For example, the TV tuner 31 is implemented as a digital TV tuner which can receive digital TV broadcast data such as terrestrial digital TV broadcasting. The TV tuner 31 further has a function of capturing video data inputted from an external device. The TV broadcast reception antenna 32 may be attached to the outside of the apparatus or may be built in the computer 1.

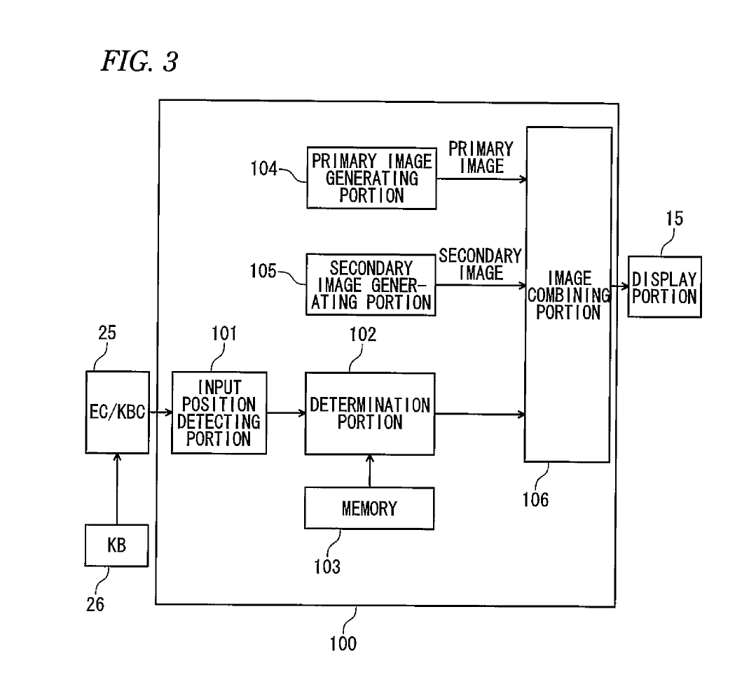

A display image data display function according to this embodiment will be described below with reference to FIG. 3. The display image data display function is performed by a controller 100. Control by the controller 100 is control by the CPU 11 which executes the display image data display application program 13B. Besides this, control may be performed by cooperation of the CPU 11 and another device or control may be performed by hardware control containing no software control.

Upon acceptance of an input to the keyboard 26, the EC/KBC 25 outputs inputted key information to an input position detecting module 101. The input position detecting module 101 outputs input position information to a determination module 102. The determination module 102 determines a position of a secondary image such as a cursor in an area of a primary image based on information of correspondence between an input position stored in a memory 103 and a screen position of the LCD 15 and the input position information sent from the input position detecting module 101, and outputs the information of the display position of the secondary image to an image combining module 106.

On the other hand, a primary image generating module 104 outputs primary image data as a target of display (such as video data for displaying video (motion images) or video data for displaying a user interface screen (UI screen) such as a menu for user's operating video displayed on a screen) to the image combining module 106.

A secondary image generating module 105 outputs secondary image data of a cursor or the like as a target of display to the image combining module 106.

The image combining module 106 combines the secondary image data sent from the secondary image generating module 105 with the image data sent from the primary image generating module 104 based on the secondary image display position information sent from the determination module 102, and outputs the combined image to the display module 15. The display module 15 displays the image outputted from the image combining module 106.

### EXAMPLE 1

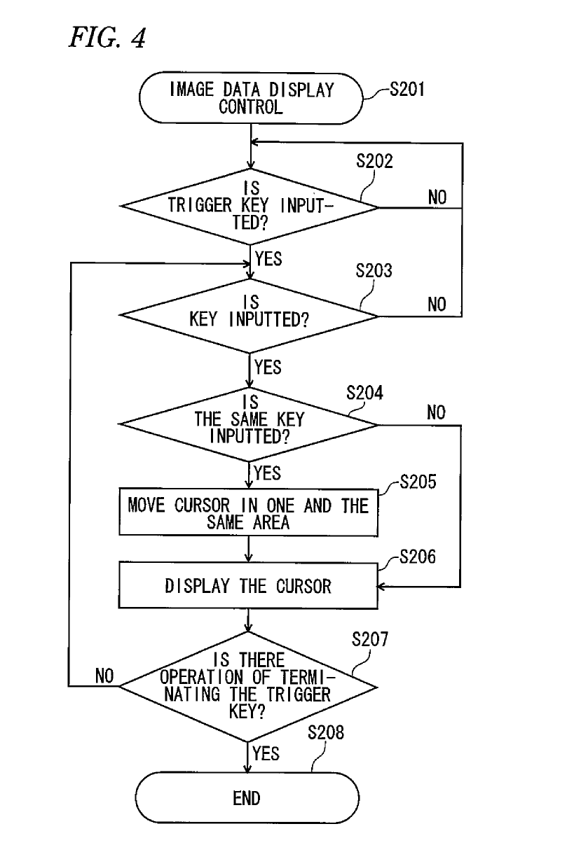

A procedure of an image data display process will be described below with reference to the flow chart shown in FIG. 4.

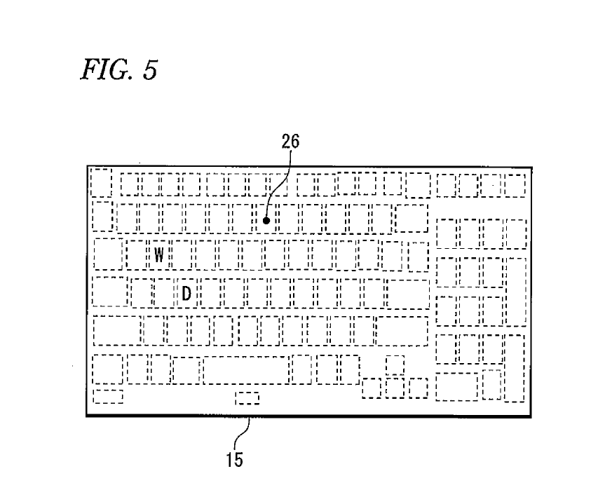

When an operation of displaying image data is performed by a user, an image data display process starts (step 201). The EC/KBC 25 determines whether a key (any predetermined key such as right shift key) in the keyboard 26 as a trigger for displaying a cursor is inputted or not (step 202). When inputting of a trigger key is detected (Yes in step 202), the flow of processing goes to step 203. Here, the inputting of the trigger key may be a state where the user releases the trigger key after once pushing down the trigger key or may be a state where the user pushes down the trigger key once and continuously. In addition, when the trigger key is pushed down, the keyboard 26 may be displayed semitransparently (to be superposed on the primary image) on the LCD 15 so as to show the user the positional relation in correspondence between the keyboard 26 and the screen of the LCD 15 as shown in FIG. 5 which will be described later.

When inputting of a key in the keyboard 26 is detected by the EC/KBC 25 (Yes in step 203), the flow of processing goes to step 204.

Determination is made as to whether the inputted key detected by the step 203 is the same as a previously inputted key or not (step 204). When the key is not the same (No in step 204), a position to display the cursor is determined by the determination module 102 and the cursor is displayed (step 206). On the other hand, when the key is the same (Yes in step 204), the cursor which has been already displayed is moved in one and the same area as will be described later (step 205). Accordingly, when the same operation is repeated, the cursor display position can be designated in the same area more finely.

When an operation of terminating the trigger key is performed by the user (Yes in step 207), display is terminated (step 208). On the other hand, when the operation of terminating the trigger key is not performed (No in step 207), the flow of processing goes to step 203.

Here, the operation of terminating the trigger key means the case where processing such as clicking or double clicking is executed for a selecting operation based on the cursor by the user's inputting a specific key (e.g. a space key or the like) after the cursor is displayed by the step 206. The operation of terminating the trigger key may mean the case where the user pushes down an escape key to cancel the operation after the cursor is displayed by the step 206. When the user once pushes down the trigger key and cursor movement is accepted in the condition that the user pushes down the trigger key continuously, the operation of terminating the trigger key may mean the case where the user stops the pushdown of the trigger key (i.e. the user releases the trigger key).

The relation between the keyboard 26 and the cursor display position will be described below with reference to a conceptual view shown in FIG. 5.

FIG. 5 shows the positional relation in correspondence between the keyboard 26 (broken line portion) and the screen of the LCD 15. In the personal computer 1 according to this embodiment, the size of the keyboard 26 is not the same as the size of the screen of the LCD 15. For this reason, the keyboard 26 is adjusted in advance in accordance with the screen of the LCD 15. In this embodiment, the keyboard 26 is expanded vertically.

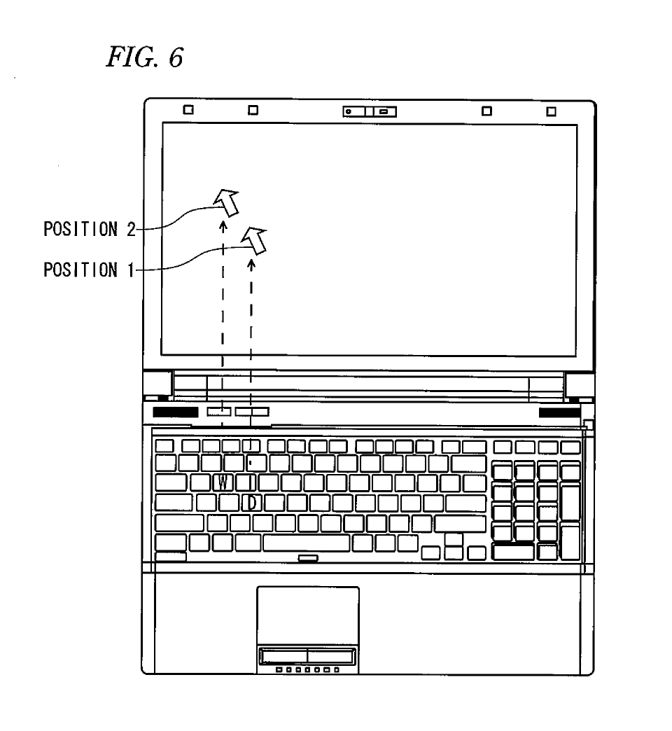

When a key in the keyboard 26 is inputted as a trigger for displaying a cursor and a key (e.g. D key) in the keyboard 26 is inputted, the cursor is displayed in a corresponding position (position 1) on the screen of the LCD 15 as shown in FIG. 6. When a W key is then inputted, the cursor is displayed in a corresponding position (position 2) on the screen of the LCD 15.

Display in the case where the same key is inputted continuously will be described below.

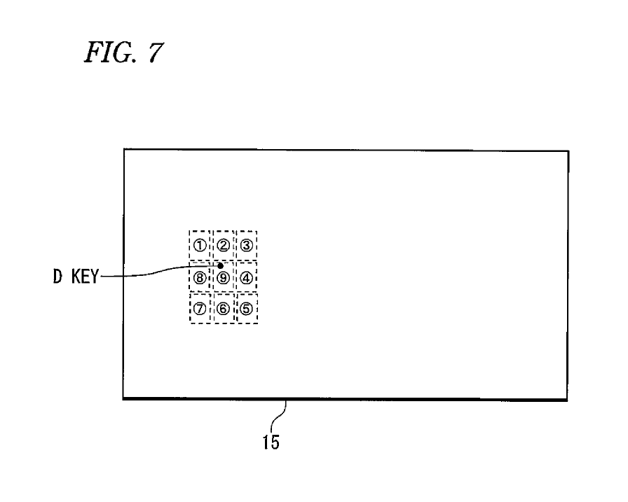

When a key in the keyboard 26 is inputted as a trigger for displaying a cursor and a key (e.g. D key) in the keyboard 26 is inputted, the cursor is displayed in a corresponding position (position 1) on the screen of the LCD 15. On this occasion, an area (broken portion in FIG. 7) around the D key is mapped. Then, when the D key is inputted again, the cursor is displayed on a portion indicated as 1 in the area. The cursor is moved from 1 to 9 successively whenever the D key is inputted. In this manner, when the same operation is repeated, the cursor display position can be designated in the same area more finely.

Although this embodiment has been described in the case where an area around the inputted key (D key) is mapped, changes may be made suitably. For example, an area where the inputted key is located in the upper left may be mapped. In addition, the positions of 1 to 9 may be changed suitably.

Alternatively, when the user pushes down the first inputted D key continuously (without releasing), the cursor may be moved from 1 to 9 successively.

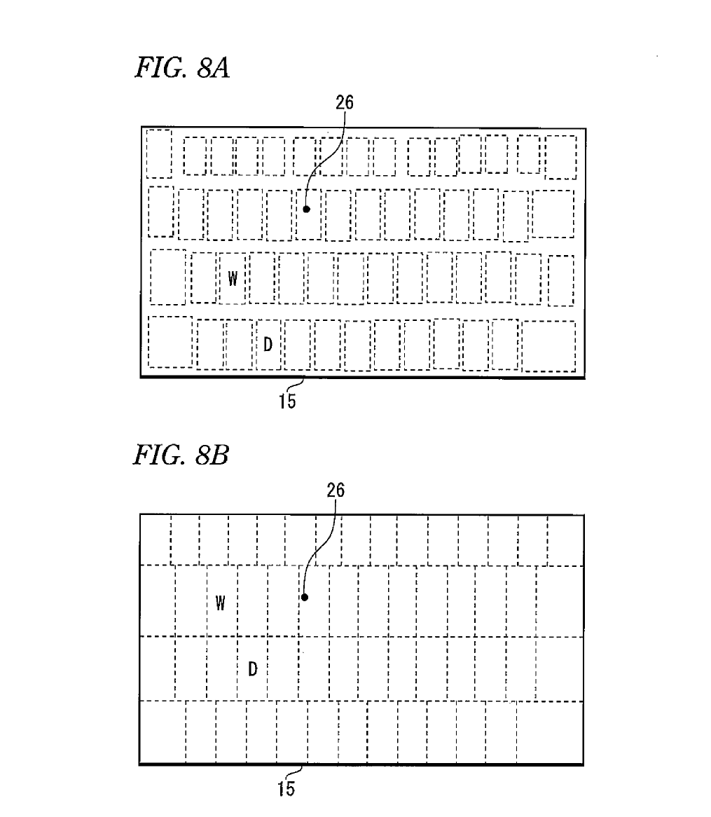

Although FIG. 5 shows an example of positional relation of all keys in the keyboard 26 on the screen of the LCD 15, the positional relation is not limited thereto. As shown in FIG. 8A, part of keys in the keyboard 26 may be made to correspond to positions on the screen of the LCD 15. AS shown in FIG. 8B, keys in the keyboard 26 may be made to correspond to positions on the screen of the LCD 15 so as to fill gaps between the respective keys in the keyboard 26.

### EXAMPLE 2

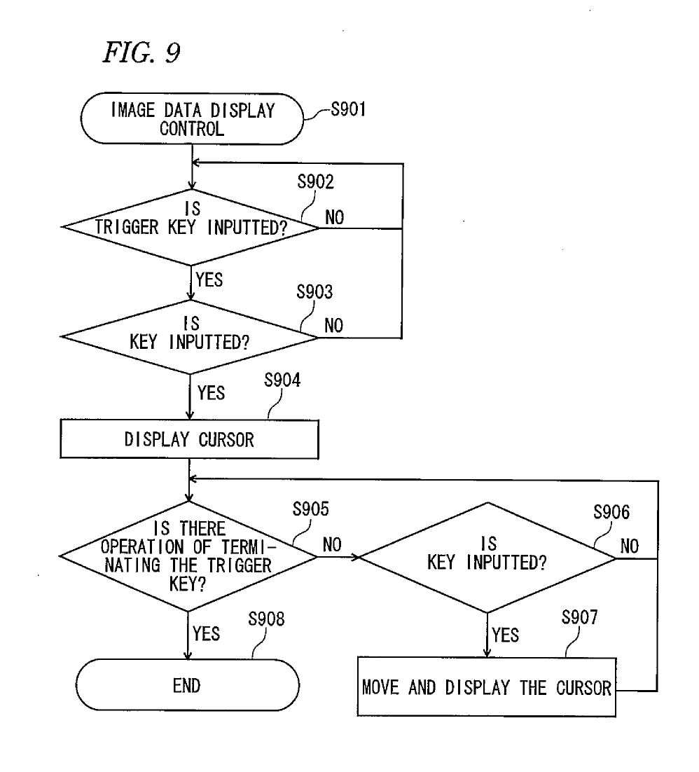

A procedure of an image data display process will be described below with reference to a flow chart shown in FIG. 9.

When an operation of displaying image data is performed by a user, an image data display process starts (step 901).

The EC/KBC 25 determines whether a key (e.g. right shift key or the like) in the keyboard 26 is inputted as a trigger for displaying a cursor or not. When inputting of the trigger key is detected (Yes in step 902), the flow of processing goes to step 903. Here, the inputting of the trigger key may be a state where the user releases the trigger key after once pushing down the trigger key or may be a state where the user pushes down the trigger key once and continuously. In addition, when the trigger key is pushed down, the keyboard 26 may be displayed semitransparently (to be superposed on the primary image) on the LCD 15 so as to show the user the positional relation in correspondence between the keyboard 26 and the screen of the LCD 15 as shown in FIG. 5 as described above.

When inputting of a key in the keyboard 26 is detected by the EC/KBC 25 (Yes in step 903), the flow of processing goes to step 904.

The cursor display position on the screen of the LCD 15 corresponding to the inputted key detected by the step 903 is determined by the determination module 102, and the cursor is displayed (step 904).

When an operation of terminating the trigger key is performed by the user (Yes in step 905), display is terminated (step 908). On the other hand, when the operation of terminating the trigger key is not performed (No in step 905), the flow of processing goes to step 906.

The operation of terminating the trigger key means the case where processing such as clicking or double clicking is executed for a selecting operation based on the cursor by the user's inputting a specific key (e.g. a space key or the like) after the cursor is displayed by the step 904. The operation of terminating the trigger key may mean the case where the user pushes down an escape key to cancel the operation after the cursor is displayed by the step 904. When the user once pushes down the trigger key and cursor movement is accepted in the condition that the user pushes down the trigger key continuously, the operation of terminating the trigger key may mean the case where the user stops the pushdown of the trigger key (i.e. the user releases the trigger key).

When inputting of a key in the keyboard 26 is detected by the EC/KBC 25 (Yes in step 906), the flow of processing goes to step 907. In the step 907, the determination module 102 determines the cursor display position based on both inputted keys detected by the steps 903 and 906, so that the cursor is displayed (step 907). In this manner, when the key operation is repeated, the cursor display position can be designated more finely.

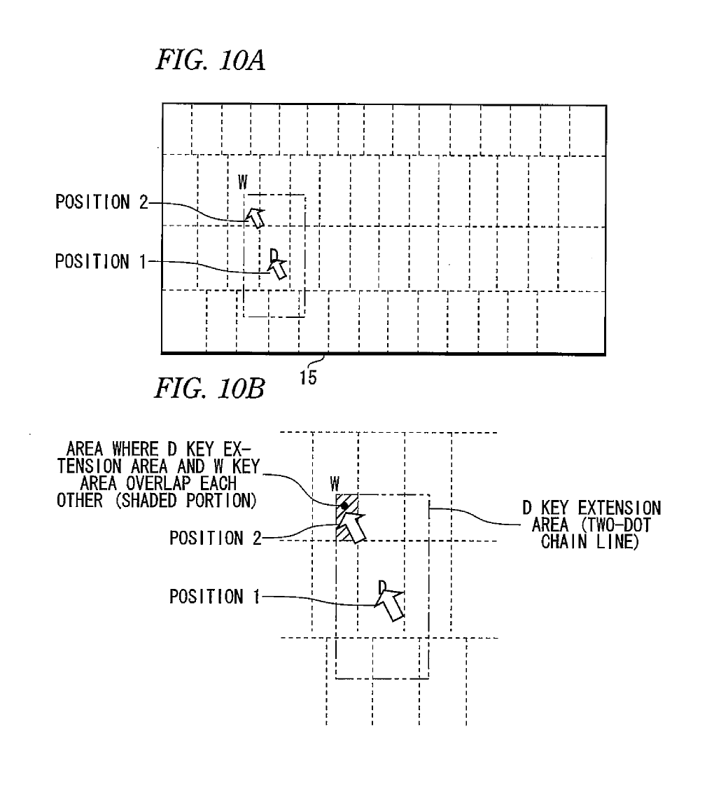

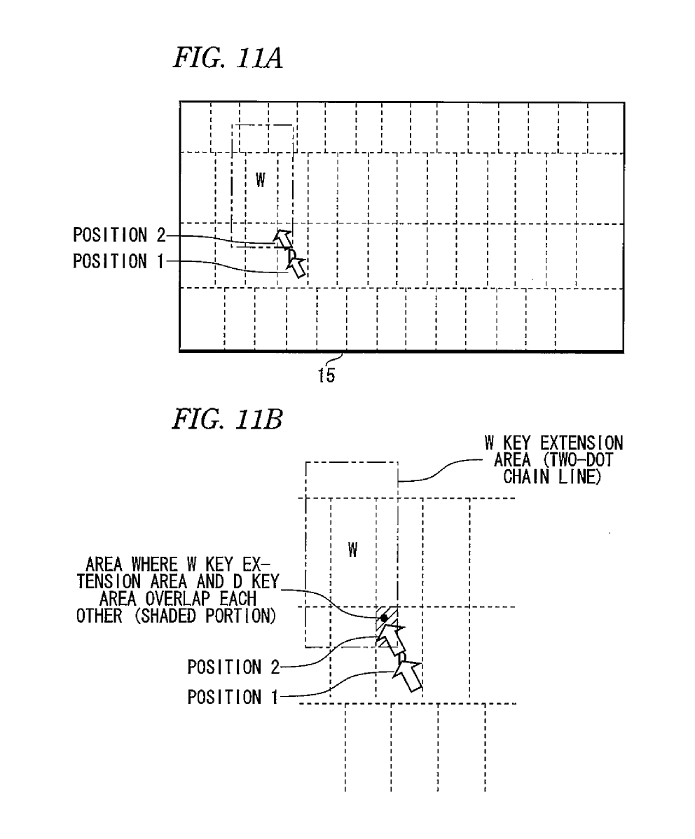

Determination of the cursor display position in the step 907 will be described with reference to FIGS. 10A and 10B and FIGS. 11A and 11B.

FIG. 10A shows the case where keys in the keyboard 26 are made to correspond to positions on the screen of the LCD 15 so as to fill gaps between the respective keys in the keyboard 26, similarly to FIG. 8B as described above. FIG. 10B is an enlarged view showing the periphery of the D key.

This example shows the case where the user pushes down the D key after pushing down the trigger key, and pushes down the W key without operation of terminating the trigger key.

The cursor is displayed in position 1 in accordance with the user's pushing down the D key after pushing down the trigger key. Then, the cursor is displayed in position 2 in accordance with the user's pushing down the W key. Incidentally, the display position may be changed from the position 1 to the position 2 so that the cursor is moved.

Operation of the controller 100 will be described. First, when inputting of the D key is detected, the cursor is displayed in the center portion of the D key. A D key extension area (two-dot chain line) is read from the memory 103. When inputting of the W key is detected, an area (shaded portion) where the D key extension area (two-dot chain line) and a W key area overlap each other is determined. The cursor is displayed in the overlap area.

FIG. 11A shows the case where keys in the keyboard 26 are made to correspond to positions on the screen of the LCD 15 so as to fill gaps between the respective keys in the keyboard 26, similarly to FIG. 8B as described above. FIG. 11B is an enlarged view showing the periphery of the D key.

This example has shown the case where the user pushes down the D key after pushing down the trigger key, and pushes the W key without operation of terminating the trigger key.

The cursor is displayed in position 1 in accordance with the user's pushing down the D key after pushing down the trigger key. Then, the cursor is displayed in position 2 in accordance with the user's pushing down the W key. Incidentally, the display position may be changed from the position 1 to the position 2 so that the cursor is moved.

Operation of the controller 100 will be described. First, when inputting of the D key is detected, the cursor is displayed in the center portion of the D key. Then, when inputting of the W key is detected, a W key extension area (two-dot chain line) is read from the memory 103. An area (shaded portion) where the W key extension area (two-dot chain line) and a D key area overlap each other is determined. The cursor is displayed in the overlap area.

Although the aforementioned embodiments have been described in the case where the electronic apparatus is implemented as a notebook type personal computer, the electronic apparatus may be implemented as a combination of a desktop type personal computer, a television set and an external keyboard.

Incidentally, the method described in each of the aforementioned embodiments may be distributed as a program which can be executed by a computer and which is stored in a recording medium such as a magnetic disk (flexible disk, hard disk, etc.), an optical disk (CD-ROM, DVD, etc.), a magneto-optical disk (MO) or a semiconductor memory.

Any recording format may be used in the recording medium as long as the recording medium is a computer readable recording medium which can store the program.

An OS (operating system) or MW (middleware) such as database management software or network software operating on a computer may execute part of each process for achieving the embodiments based on an instruction of the program installed from the recording medium into the computer.

In addition, the recording medium in the invention includes not only a medium independent of the computer but also a recording medium in which a program transmitted via LAN, Internet, etc. is downloaded and stored or temporarily stored.

The number of recording media is not limited to one. The case where processing in the embodiments is executed from a plurality of media may be included in the recording medium in the invention. Any medium configuration may be used.

Incidentally, the computer in the invention is a computer which executes each process in the embodiments based on the program stored in the recording medium. Any configuration may be used. For example, a single apparatus such as a personal computer may be used or a system including a plurality of apparatuses connected to each other on a network may be used.

The function of each module described in the embodiments may be implemented by a software application executed by a processor. It may be implemented by a processing circuit constituted by hardware. It may be implemented by hardware. It may be implemented by a combination of a software application, hardware and a software module.

Although some embodiments of the invention have been described, the embodiments are presented by way of example but do not have any intention to limit the scope of the invention. These novel embodiments can be performed in other various modes and can be omitted, replaced and changed variously without departing from the gist of the invention. These embodiments and modifications thereof are included in the scope and gist of the invention and included in the invention described in Claims and its equivalent scope.

According to the electronic apparatus of at least one embodiment described above, based on the determination module 102, a user can know in advance which key in the remote controller should be pushed down in order to move the cursor to a desired position on the screen. It would be easy for the user to move the cursor to the desired position on the screen.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
an input module comprising a plurality of keys;
a controller configured to display a primary image and a secondary image, the secondary image indicative of an input position on the primary image; and
a determination module configured to determine a position of the secondary image in an area of the primary image based on a position of the key inputted in an area of the input module.

2. The electronic apparatus of claim 1, wherein:
when two or more keys are inputted on the input module, the determination module determines a position of the secondary image in an area of the primary image based on positions of the keys inputted in the area of the input module.

3. The electronic apparatus of claim 1, wherein:
the plurality of keys include a first key and a second key,
if the first key is inputted continuously more than once, the determination module is configured to move a position of the secondary image in an area of the primary image corresponding to the first key.

4. The electronic apparatus of claim 1, wherein:
the secondary image comprises a cursor.

5. A display control method comprising:
detecting inputting of any one of keys;
determining a position of a secondary image in an area of a primary image based on a position of the detected key in an input area, the secondary image indicative of an input position on the primary image; and
displaying the secondary image together with the primary image based on the determined position.

6. A non-transitory computer-readable medium storing a program that causes a computer to execute image displaying processing comprising:
detecting inputting of any one of keys;
determining a position of a secondary image in an area of a primary image based on a position of the detected key in an input area, the secondary image indicative of an input position on the primary image; and
displaying the secondary image together with the primary image based on the determined position.
